(19) United States
(12) Patent Application Publication
(10) Pub. No.: US 2013/0333908 A1
(43) Pub. Date: Dec. 19, 2013

(54) TRANSMISSION HOUSING

(71) Applicant: Robert Bosch GmbH, Stuttgart (DE)

(72) Inventors: Juergen Lennartz, Ostfildern (DE); Achim Duesselberg, Kirchheim Unter Teck (DE)

(21) Appl. No.: 13/916,705

(22) Filed: Jun. 13, 2013

(30) Foreign Application Priority Data
Jun. 13, 2012 (DE) 10 2012 209 868.2

(51) Int. Cl. B25F 5/02

(52) U.S. Cl. CPC B25F 5/02
USPC 173/90

(57) ABSTRACT

A transmission housing, in particular for a hammer drill and/or percussion hammer, for accommodating a percussion mechanism includes at least one housing part and at least one cover part adjacent to the housing part. The cover part is configured to close off the transmission housing in a direction opposite to a percussion direction.

This application claims priority under 35 U.S.C. §119 to patent application no. DE 10 2012 209 868.2, filed on Jun. 13, 2012 in Germany, the disclosure of which is incorporated herein by reference in its entirety.

### BACKGROUND

There are already known transmission housings, in particular for a hammer drill and/or percussion hammer, which are provided to accommodate a percussion mechanism, and which have at least one housing part and at least one cover part.

### SUMMARY

The disclosure is based on a transmission housing, in particular for a hammer drill and/or percussion hammer, which is provided to accommodate a percussion mechanism, and which has at least one housing part and at least one cover part.

It is proposed that the cover part closes off the transmission housing in a direction opposite to a percussion direction. A “hammer drill and/or percussion hammer” in this context is to be understood to mean, in particular, a power tool that is provided with a rotating or non-rotating tool for the purpose of performing work on a workpiece, the power tool being able to apply percussive impulses to the tool. Preferably, the power tool is realized as a hand power tool that is guided manually by a user. Preferably, the hand power tool has a hand power tool housing, which accommodates and at least partially surrounds the transmission housing. A “percussion mechanism” in this context is to be understood to mean, in particular, a device having at least one component that is provided to generate and/or transmit a percussive impulse, in particular an axial percussive impulse, to a tool disposed in a tool holder. Such a component can be, in particular, a striker, a striking pin, a guide element such as, in particular, a hammer tube and/or a piston such as, in particular, a piston tube, and/or a different component, considered appropriate by persons skilled in the art. A “housing part” in this context is to be understood to mean, in particular, a preferably integrally realized main part of the transmission housing. Preferably, the housing part is produced in a casting process such as, in particular, an injection molding process and/or die casting process. Preferably, the housing part undergoes reworking, in particular on bearing and sealing faces, preferably in a material removing process such as a milling, drilling and/or grinding process. The housing part is preferably made from a metal, in particular from a light metal such as an aluminum alloy and/or magnesium alloy. Also conceivable are other materials, such as a plastic, in particular a fiber reinforced plastic. The housing part has, in particular, bearing locations for accommodating the percussion mechanism and a drive unit. A “drive unit” in this context is to be understood to mean, in particular, a motor, preferably an electric motor, and/or a motor transmission unit. The transmission unit can be provided, in particular, to drive the percussion mechanism. Preferably, the housing part includes bearing locations for further parts such as, in particular, further transmission parts such as, in particular, an eccentric transmission comprising an eccentric. The eccentric transmission can be provided, in particular, for the purpose of cyclically driving the piston of the percussion mechanism. Preferably, the housing part is provided to ensure a position of the components, mounted at the bearing locations, in relation to each other that is admissible for operation, and/or to absorb and/or to transfer forces and/or moments acting on the components, and/or to support the components. A “cover part” in this context is to be understood to mean, in particular, a part of the transmission housing that is provided, in particular, to close a mounting opening of the transmission housing. A “mounting opening” in this context is to be understood to mean, in particular, an opening of the transmission housing that is provided for inserting into the transmission housing, during mounting, components that are to be accommodated by the transmission housing. In particular, the mounting opening can be provided for inserting the hammer tube and/or eccentric transmission into the transmission housing during the mounting operation. When in an operationally ready, assembled state, with the mounting opening closed, the transmission housing preferably closes off outwardly, at least largely in a tight manner, a transmission space delimited by the transmission housing. “At least largely” in this context is to be understood to mean, in particular, that a total remaining flow cross section between the transmission space and an environment of the transmission housing is less than 5%, preferably less than 1%, particularly preferably less than 0.1% of a total surface of the transmission housing. A “percussion direction” in this context is to be understood to mean, in particular, the direction in which the percussion mechanism emits percussive impulses during percussive operation. In particular, the hammer tube can be oriented in the percussion direction, and the striker and/or the piston can be moved, in the hammer tube, in the percussion direction and in a direction opposite to same. Preferably, a tool receiver is disposed on the transmission housing, in the percussion direction. The tool receiver is preferably mounted on the hammer tube. Opposite to the percussion direction, the housing part is preferably closed off by a closing-off edge. The closing-off edge preferably constitutes the mounting opening. The cover part preferably continues the transmission housing, in a direction opposite to the percussion direction, as far as a rear end. A “rear end” in this context is to be understood to mean, in particular, the greatest extent of the transmission housing in a direction opposite to the percussion direction. The mounting opening can have a particularly large cross section. Components can be mounted particularly easily. The transmission housing is preferably seated on the hand power tool housing and/or at least partially surrounded by the hand power tool housing. Particularly preferably, a part of the transmission housing in a direction opposite to the percussion direction, which comprises the cover part, is surrounded by the hand power tool housing. The cover part can be located inside the hand power tool housing. The cover part can be concealed from a user. The appearance of the hand power tool need not be affected by the cover part. The cover part can be realized in a particularly functional manner. There is no need for a special design for purely visual reasons.

Further, it is proposed that the housing part has a sealing surface for sealing the housing part with the cover part, having surface normals that, with the percussion direction, enclose an angle of between 0° and 80°. A “sealing plane” in this context is to be understood to mean, in particular, a surface that preferably runs along the closing-off edge and that is provided to seal the housing part with the cover part, in particular for liquids and/or gases. Preferably, a sealing element, in particular an elastomer element, which constitutes a seal with the sealing surface, is disposed on the housing part and/or on the cover part. Preferably, the sealing surface has a flat configuration in at least one direction. A “surface normal” in this context is to be understood to mean, in particular, a normal to the sealing surface in regions of the sealing surface against which the cover part or a sealing element of the cover part bears when the cover part is closed. The cover part can seal the housing part in an effective manner. In particular, the cover part can be joined to the housing part in the percussion direction and, when the cover part is being closed, the seal and/or the sealing element can be biased for the purpose of sealing in the percussion direction. Preferably, a side view of the closing-off edges forms with a percussion axis, at least substantially, an angle of 30°-90°. Preferably, a top view of the closing-off edges forms with the percussion axis, at least substantially, an angle of 80°-90°, particularly preferably of 89°-90°. An “angle” in this context is to be understood to mean the smallest enclosed angle. “At least substantially” in this context is to be understood to mean, in particular, that more than 75%, preferably more than 90%, particularly preferably more than 95% of a closing-off edge length forms, with the percussion axis, an angle that is within the stated range. A “side view” in this context is to be understood to mean, in particular, a view in a direction perpendicular to the percussion axis and perpendicular to a drive shaft of the drive unit. A “top view” in this context is to be understood to mean, in particular, a view in a direction perpendicular to the percussion axis, in the direction of the drive shaft of the drive unit. The mounting opening can afford particularly good accessibility. Components, in particular the hammer tube, can be introduced into the transmission housing and mounted in a particularly satisfactory manner in the percussion direction. Components, in particular drive pinions and/or the eccentric transmission, can be introduced into the transmission housing and mounted in a particularly satisfactory manner in a direction perpendicular to the drive shaft.

Further, it is proposed that the housing part is realized, at least substantially, in the form of a tube. “In the form of a tube” in this context is to be understood to mean, in particular, a shape in which a closed circumferential surface extends around a longitudinal axis. A “longitudinal axis” in this context is to be understood to mean, in particular, an axis in a main extent, in particular a percussion axis in the percussion direction. “At least substantially” in this context is to be understood to mean, in particular, that more than 50%, preferably more than 60%, particularly preferably more than 75% of the length of the housing part, in the direction of main extent, is realized in the form of a tube. Particularly preferably, the tubular part is realized in a continuous manner, i.e. without non-tubular segments. Particularly preferably, the tubular part has an at least approximately circular cross section. “At least approximately” in this context is to be understood to mean, in particular, a deviation of a radius of the circumferential surface around the longitudinal axis of less than 25%, preferably less than 10%, particularly preferably less than 5% of a circular cross section. The housing part can have an at least largely closed surface. The housing part can be particularly robust and/or torsionally stiff. The housing part can be produced particularly easily. In a casting process, a core that is necessary for producing an inside of the housing part can preferably be demolded in one working step, in the percussion direction, through the mounting opening.

Further, it is proposed that a circumferential surface of the housing part that is opposite a motor receiver of the housing part is realized in a closed manner. A motor receiver in this context is to be understood to mean, in particular, a device provided to receive the drive unit and/or a drive housing surrounding the drive unit. The drive housing can be realized so as to be at least partially integral with the housing part of the transmission housing. Preferably, the motor receiver has a recess, through which the drive shaft projects into the transmission space, and has mating and sealing surfaces, and fastening means, provided for positioning, fastening and sealing the drive unit on the transmission housing. A “circumferential surface . . . that is opposite” in this context is to be understood to mean, in particular, a part of the circumferential surface that, from the point of view of the motor receiver, in the direction of the drive shaft, is disposed at least above the percussion axis. Particularly preferably, the circumferential surface is closed above the motor receiver. A “closed circumferential surface” in this context is to be understood to mean, in particular, that the circumferential surface, from its front end in the percussion direction as far as the closing-off edge, is without recesses having a surface area of more than 5 cm², preferably not more than 1 cm². Particularly preferably, the circumferential surface, from a front end in the percussion direction as far as the closing-off edge, is without recesses. The housing part can be particularly torsionally stiff. There is no need for further seals and coverings for recesses. The transmission housing can be particularly light.

Further, it is proposed that the cover part is realized without bearing locations. “Without bearing locations” in this context is to be understood to mean, in particular, without bearing locations of the drive unit, the eccentric transmission and/or the percussion mechanism. In particular, the cover part does not have any supporting function for parts of the drive unit, the eccentric transmission, the percussion mechanism or further transmission parts. In comparison with the housing part, the cover part has to absorb only small forces. In comparison with the housing part, the cover part can be composed of a less solid material, in particular of a plastic. The cover part can be produced in a particularly inexpensive manner. The cover part can be designed in a particularly free manner. The cover part can have functions in which bearing locations and/or introduction of large forces into the cover part are disadvantageous.

Also proposed is at least one housing profiling, disposed on an inside of the housing part in the percussion direction. A “housing profiling” in this context is to be understood to mean, in particular, a projection on the inside of the housing part. The housing profiling can be, in particular, a stiffening rib, a heat transfer rib and/or a bearing location, in particular for the hammer tube. A “heat transfer rib” in this context is to be understood to mean, in particular, a projection that, at least substantially, enlarges the surface of the inner wall, in order to achieve a better heat transfer from the transmission space into the housing part. “Disposed in the percussion direction” in this context is to be understood to mean, in particular, that a surface of a cross section of the housing profilings that projects into the transmission space is constant or decreases in a direction opposite to the percussion direction. Particularly advantageously, a surface of the cross section of the transmission space is constant or increases in a direction opposite to the percussion direction. Advantageously, the inside of the housing part can be produced in a casting process, by a core that can be demolded, in a direction opposite to the percussion direction, through the mounting opening.

Further, it is proposed that a control unit is disposed on the cover part. A “control unit” in this context is to be understood to mean, in particular, a component provided for open-loop and/or closed-loop control of the percussion mechanism and/or of the drive unit. The control unit can constitute the open-loop and/or closed-loop control of the hand power tool or a part thereof. In particular, the control unit can be provided to acquire measurement values and/or evaluate signals and/or output positioning and feedback control quantities and/or further signals. Preferably, the control unit is realized as an electrical and/or electronic control unit. “Disposed” in this context is to be understood to mean, in particular, connected and/or seated. The control unit can be realized in a particularly compact manner with the cover part. The control unit can be disposed particularly close to the percussion mechanism and/or to the drive unit. Signal and cable paths can be particularly short.

Further, it is proposed that the control unit is at least partially embedded in the cover part. “Embedded” in this context is to be understood to mean, in particular, cast by means of a casting process, such as an injection molding process. In particular, a material of the cover part can partially surround the control unit, in particular be in direct contact with components of the control unit and completely enclose the latter, at least partially. Preferably, at least one printed circuit board of the control unit is completely embedded in the cover part. Particularly preferably, components of the control unit that do not react with the environment of the cover part are completely embedded in the cover part. Components that do interact with the environment of the cover part, such as, in particular, cables and/or signal lines and/or sensors and/or actuators, can preferably be disposed, at least partially, outside of the cover part. The control unit can be particularly well protected against environmental influences, in particular against moisture and/or lubricants and/or dirt and/or mechanical damage.

Further, it is proposed that the control unit has at least one sensor and/or at least one actuator. A “sensor” in this context is to be understood to mean, in particular, a pressure sensor and/or a temperature sensor. The sensor can be provided, in particular, to measure a pressure and/or a temperature inside or outside of the transmission space.

The control unit can use measurement values of the sensor in order to identify an operating state of the percussion mechanism and/or to define operating parameters, such as a percussion frequency, in particular a maximum percussion frequency. An “actuator” in this context is to be understood to mean, in particular, a device for executing a mechanical motion, such as a servomotor, a solenoid, or other positioning drives known to persons skilled in the art. The actuator can be provided, in particular, to switch over a transmission and/or to switch the percussion mechanism into an idling mode and/or into a percussion mode. Further possible applications for an actuator are also conceivable. Preferably, the cover part can comprise valves and/or air vents. The valves and/or air vents can be provided, in particular, for targeted inlet and discharge of air into and from the transmission space. The valves can be provided to influence and/or to effect open-loop control and/or closed-loop control of a pressure inside the percussion mechanism, in particular inside the hammer tube. The valves can be provided, in particular, to regulate a percussion performance of the percussion mechanism. Preferably, the sensors, actuators, valves and/or micro-valves and/or air vents can project into the transmission space and/or be directly or indirectly connected to the transmission space and/or to components in the transmission space. The cover part can be realized in a particularly compact manner with the control unit, and can directly comprise means for determining measurement values of the percussion mechanism and/or of the environment of the percussion mechanism and/or of the transmission housing and/or for influencing the percussion mechanism and/or the operating state of the percussion mechanism. Functions of the cover part comprising the control unit can be particularly multifarious. The cover part comprising the control unit can be realized as a module that can be attached particularly easily to the housing part and/or removed and/or exchanged particularly easily in the case of servicing.

Also proposed is a hand power tool having a transmission housing having the features described. The hand power tool can have the advantages described.

### BRIEF DESCRIPTION OF THE DRAWINGS

Further advantages are given by the following description of the drawings. The drawings show two exemplary embodiments of the disclosure. The drawings, the description and the claims contain numerous features in combination. Persons skilled in the art will also expediently consider the features individually and combine them to create appropriate further combinations.

In the drawing:

FIG. 1 shows a section through a schematic representation of a transmission housing, having a cover part,

FIG. 2 shows a side view of the transmission housing, having the cover part,

FIG. 3 shows a view of a schematic representation of a transmission housing, having a cover part, in a second exemplary embodiment, and

FIG. 4 shows a section through the schematic representation of the transmission housing, having the cover part, of the second exemplary embodiment.

### DETAILED DESCRIPTION

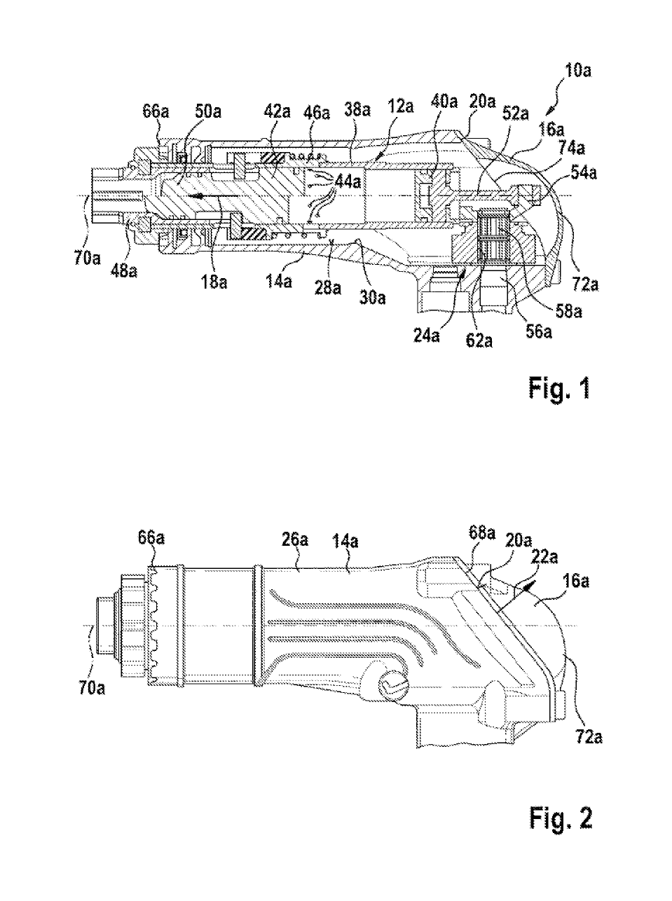

FIGS. 1 and 2 show a transmission housing 10a for a hammer drill and/or percussion hammer, which is provided to accommodate a percussion mechanism 12a, and which has at least one housing part 14a and at least one cover part 16a. The cover part 16a closes off the transmission housing 10a in a direction opposite to a percussion direction 18a.

The percussion mechanism 12a has a hammer tube 38a, in which a piston 40a and a striker 42a are guided so as to be movable in the percussion direction 18a and in a direction opposite to the same. If, when the percussion mechanism 12a is in a percussion mode, in which idling openings 44a are closed by a control sleeve 46a (above the central axis, in the direction of the percussion direction 18a of the hammer tube 38a in FIG. 1), the piston 40a is moved in the percussion direction 18a, the piston 40a compresses a volume enclosed between the piston 40a, the striker 42a and the hammer tube 38a. The striker 42a is accelerated in the percussion direction 18a and impacts against a striking pin 50a seated in a tool holder 48a. The striker 42a emits a percussion impulse to the striking pin 50a, which transmits this impulse, at least partially, to a tool, not represented in greater detail here, that is clamped in the tool holder 48a. The piston 40a is moved back, in a direction opposite to the percussion direction 18a, and the striker 42a follows this movement, whereupon a subsequent percussion cycle can be effected. The piston 40a is driven, via a connecting rod 52a, by an eccentric 54a. The eccentric 54a is seated in a rotationally fixed manner on a drive shaft 56a, which is seated on two rolling bearings 58a, on a motor receiver 24a of the housing part 14a. The drive shaft 56a is part of a drive unit, not represented in greater detail here, which comprises a motor and a transmission, and which is disposed outside of the housing part 14a. The motor receiver 24a comprises a recess 62a, through which the drive shaft 56a projects into a transmission space 64a, in which the percussion mechanism 12a, comprising the eccentric 54a, is disposed. The recess 62a accommodates the rolling bearings 58a. The drive shaft 56a forms a right angle with the percussion direction 18a. The housing part 14a has a sealing surface 20a for sealing the housing part 14a with the cover part 16a. A surface normal 22a of the sealing surface 20a encloses, with the percussion direction 18a, an angle of between 0° and 80°, depending on the location on the sealing surface 20a. The housing part 14a, from a front end 66a in the percussion direction 18a as far as a closing-off edge 68a in a direction opposite to the percussion direction 18a, is realized substantially in the form of a tube. The closing-off edge 68a constitutes a mounting opening 74a of the transmission housing 10a, which is closed by the cover part 16a. A circumferential surface 26a of the housing part 14a that is opposite the motor receiver 24a in the direction of the drive shaft 56a is realized so as to be closed around a longitudinal axis 70a of the housing part 14a that is disposed in the percussion direction 18a. On the side of the housing part 14a that is opposite the motor receiver 24a, the closing-off edge 68a is offset back in relation to the drive shaft 56a, in the percussion direction 18a, by a diameter of the eccentric 54a. Thus, during a mounting operation, the rolling bearings 58a and the eccentric 54a are easily inserted in the direction of the drive shaft 56a, from the side that is opposite the motor receiver 24a, through the mounting opening 74a, while the hammer tube 38a can be inserted in the housing part 14a in the percussion direction 18a, through the mounting opening 74a. The cover part 16a is joined to the housing part 14a in a joining direction that is oriented in the percussion direction 18a, and closes off the transmission housing 10a at a rear end 72a, in a direction opposite to the percussion direction 18a. The cover part 16a is realized without bearing locations. The housing part 14a has housing profilings 30a, disposed on an inside 28a, in the percussion direction. The housing profilings 30a serve to seat the hammer tube 38a and improve a transfer of heat from the transmission space 64a. The housing part 14a is made of aluminum in a die casting process, the inside 28a being shaped such that, in the die casting process, a casting core that forms the inside 28a can be removed through the mounting opening 74a, in a direction opposite to the percussion direction 18a. The transmission housing 10a is mounted on a hand power tool housing, not represented here, of the hammer drill and percussion hammer, the cover part 16a being located completely inside the hand power tool housing. The transmission housing 10a, with the tool holder 48a, projects out of the hand power tool housing in the percussion direction 18a. What proportion of the transmission housing 10a is disposed outside of the hand power tool housing can be determined by persons skilled in the art.

The following description and the drawings of a further exemplary embodiment are limited substantially to the differences between the exemplary embodiments, and in principle reference may also be made to the drawings and/or description of the other exemplary embodiments in respect of components denoted in a like manner, in particular in respect of components having the same references. In order to differentiate the exemplary embodiments, instead of the letter a of the first exemplary embodiment, the letter b has been appended to the references of the further exemplary embodiment.

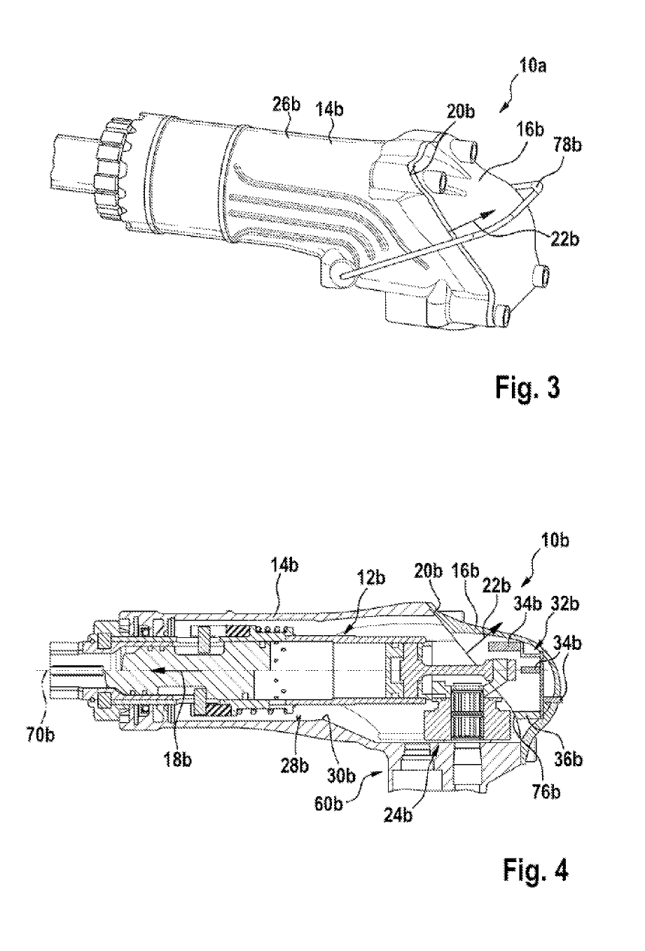

FIGS. 3 and 4 show a transmission housing 10b for a hammer drill and percussion hammer, which is provided to accommodate a percussion mechanism 12b, and which has at least one housing part 14b and at least one cover part 16b, in a second exemplary embodiment. The transmission housing 10b of the second exemplary embodiment differs from the first exemplary embodiment, in particular, in that a control unit 32b is disposed on the cover part 16b. The control unit 32b is provided for open-loop control and closed-loop control of a drive unit 60b and of the percussion mechanism 12b of the hammer drill and percussion hammer The control unit 32b is partially embedded in the cover part 16b. For this purpose, the control unit 32b is encapsulated in the cover part 16b. Disposed on the control unit 32b are sensors 34b and an actuator 36b, which engage in a transmission space 64b and in an environment of the transmission housing 10b, and which measure pressures and temperatures. An air vent 76b can be opened and closed by the control unit 32b in dependence on a pressure difference in the transmission space 64b and the environment of the transmission housing 10b, and serves to inlet and discharge air into and from the transmission space 64b. The air vent 76b is opened and closed by the control unit 32b by means of the actuator 36b. A locking stirrup 78b is provided to secure the cover part 16b on the housing part 14b.

What is claimed is:

1. A transmission housing for accommodating a percussion mechanism, comprising:
at least one housing part; and
at least one cover part adjacent to the housing part, the cover part being configured to close off the transmission housing in a direction opposite to a percussion direction.

2. The transmission housing according to claim 1, wherein the housing part has a sealing surface configured to seal the housing part with the cover part, the sealing surface having surface normals that, with the percussion direction, enclose an angle of between 0° and 80°.

3. The transmission housing according to claim 1, wherein the housing part is realized, at least substantially, in the form of a tube.

4. The transmission housing according to claim 1, wherein a circumferential surface of the housing part that is opposite a motor receiver of the housing part is realized in a closed manner.

5. The transmission housing according to claim 1, wherein the cover part is realized without bearing locations.

6. The transmission housing according to claim 1, wherein at least one housing profiling is disposed on an inside of the housing part in the percussion direction.

7. The transmission housing according to claim 1, further comprising a control unit disposed on the cover part.

8. The transmission housing according to claim 7, wherein the control unit is at least partially embedded in the cover part.

9. The transmission housing according to claim 7, wherein the control unit has one or more of at least one sensor and at least one actuator.

10. A hand power tool, comprising:
a transmission housing including:
at least one housing part; and
at least one cover part adjacent to the housing part, the cover part being configured to close off the transmission housing in a direction opposite to a percussion direction.

11. The transmission housing according to claim 1, wherein the transmission housing is for one or more of a hammer drill and a percussion hammer
